(19) United States
(12) Patent Application Publication
(10) Pub. No.: US 2010/0153736 A1
(43) Pub. Date: Jun. 17, 2010

(54) METHOD FOR ISOLATING SPECIAL FUNCTIONALITIES IN FIELD DEVICES USED IN AUTOMATION TECHNOLOGY

(76) Inventor: Markus Kilian, Freiburg (DE)

Correspondence Address: BACON & THOMAS, PLLC, 625 SLATERS LANE, FOURTH FLOOR, ALEXANDRIA, VA, 22314-1176, US

(21) Appl. No.: 12/309,676

(22) PCT Filed: Jun. 28, 2007
(86) PCT No.: PCT/EP2007/056510

§ 371 Date: Jul. 13, 2009

(30) Foreign Application Priority Data
Jul. 27, 2006 (DE) 10 2006 035 526.1

(51) Int. Cl. G06F 21/00

(52) U.S. Cl. 713/185; 713/182

(57) ABSTRACT

A method for activating special functionalities in field devices used in automation technology uses an activation code, encrypted with a private key and containing an activation option and field-device-specific information transferred to a field device. Decrypting of the activation code occurs with a public key stored in the field device. Then, the field-device-specific information contained in the activation code is compared with information stored in the field device. If these two pieces of information, match, then the activation option in the activation code is ascertained, and the corresponding special functionality is activated. This method makes it possible to activate special functionalities securely in field devices.

The invention relates to a method for activating special functionalities in field devices used in automation technology.

In automation technology, field devices are often used that serve to register and/or influence process variables. Examples of such field devices are fill level measuring devices, mass flow meters, pressure and temperature measuring devices, etc., that, as sensors, register the corresponding process variables, fill level, flow, pressure and temperature.

Actuators serve to influence process variables. For example, they control, as valves, the flow of a liquid in the cross section of a pipe, or, as pumps, the level in a container

Many such field devices are manufactured and sold by the company, Endress+Hauser.

Usually, in modern manufacturing plants, field devices are connected via fieldbus systems (HART, Profibus, Foundation Fieldbus, etc.) with superordinated units (e.g. control systems or control units). These superordinated units serve, among other things, for process control, process visualization, process monitoring, as well as for start-up of field devices. Generally, those units are generally designated as field devices, which are directly attached to a fieldbus and serve for communication with the superordinated units (e.g. remote I/O, gateway, linking devices).

Usually fieldbus systems are integrated into enterprise networks. Thus, process and/or field device data can be accessed from different areas of an enterprise.

For world-wide communication, company networks can also be connected to public networks, e.g. the Internet.

Modern field devices often have a standardized fieldbus interface for communication with an open fieldbus system and/or a proprietary interface for manufacturer-specific communication with a service/control unit. Frequently, the service units are portable mini-computers (laptops, Palms, etc.), known from the consumer electronics area (office and home computers).

Some field devices exhibit special functionalities, which are usable by special order and factory activation.

In the case of volumetric flow meters, the following special functionalities, for example, are well known: Dosing functions for batch operation, diagnostic functions, viscosity measuring functions, density measuring functions. In the case of fill level measuring instruments, a flow measurement at an open channel or a pump control, which is expanded compared to the standard version, can be implemented as special functions. A later equipping of devices already bought by the customer is, however, not possible.

In order to avoid this, some field devices have special functionalities, which can be activated with an appropriate hardware key (dongle).

The handling of these hardware keys is very complex. In addition they are relatively expensive.

A simpler possibility is that the field device manufacturer provides an activation code for the user's disposal, which permits the use of special functionalities for a certain type of field device.

Such an activation code can, however, be simply passed on and can also be used with other field devices.

In order to avoid the use of activation codes with other field devices, the serial numbers of the respective field devices are processed in the production of safer activation codes. This occurs e.g. by means of an EXOR gate, wherein the serial number and a corresponding activation option, which must both be present in binary form, are combined accordingly. The activation option is retrieved in the field device from the activation code. This occurs also through use of an EXOR gate.

Such symmetrical methods have some disadvantages in principle. They can be decrypted relatively easily and thereby give frivolous users the possibility of generating activation codes for further field devices in an unauthorized way.

It is an object of the invention to specify a simple method for activating special functionalities in field devices used in automation technology, which does not exhibit the disadvantages specified above, that in particular prevents the unauthorized use of activation codes.

This object is solved by the method steps defined below in claim 1.

A fundamental idea of the invention is to use an asymmetrical encryption method for activation codes.

The activation code is, in such case, generated with a private key by the manufacturer. The decrypting of the activation code takes place in the field device with a public key.

Further developments of the invention are indicated in the dependent claims.

The invention will now be explained in greater detail on the basis of an example of an embodiment presented in the drawing, the figures of which show as follows:

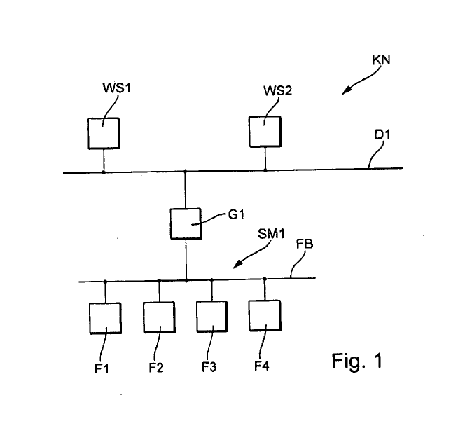

FIG. 1 schematic drawing of an automation technology network having several field devices;

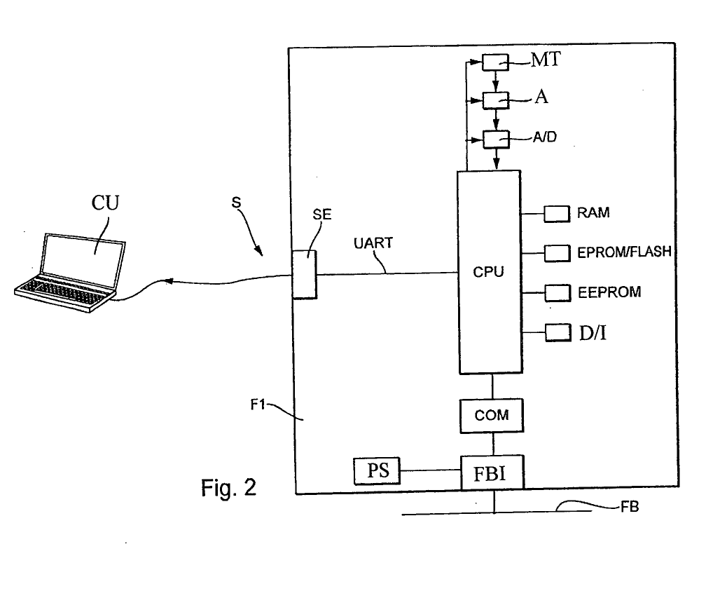

FIG. 2 block diagram of a field device; and

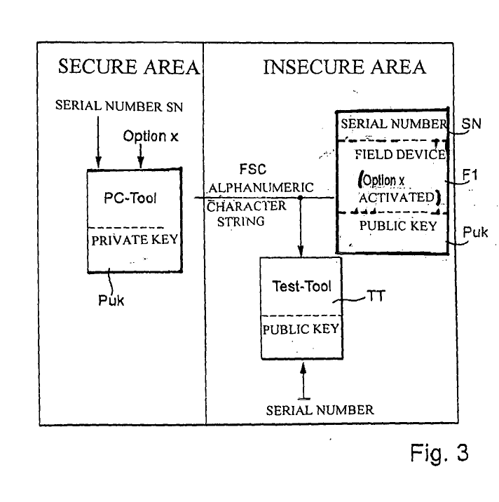

FIG. 3 diagram for the production and use of an activation code.

FIG. 1 shows a communication network KN of automation technology in more detail. Connected to a data bus D1 are several computer units (work stations) WS1, WS2. These computer units serve as superordinated units (control system and/or control unit), among other things, for process visualization, process supervision, and for engineering, as well as for servicing and monitoring field devices. The data bus D1 works, for example, according to the Profibus DP-standard or the HSE (High Speed Ethernet) standard of Foundation Fieldbus. Via a gateway G1, which is also called a linking device, field controller, or also segment coupler, the data bus D1 is connected with a fieldbus segment SM1. The fieldbus segment SM1 includes several field devices F1, F2, F3, F4, which are connected with one another by a fieldbus FB. The field devices F1, F2, F3, F4 can be either sensors or actuators. The fieldbus FB works according to the one of the well-known communication standards, e.g. Profibus, Foundation Fieldbus or HART.

In FIG. 2, a block diagram of a field device according to the invention, F1 for example, is shown in more detail. A processor unit CPU is connected for measured variable processing via an analog-digital converter A/D and an amplifier A with a measuring transducer MT, which registers a process variable (e.g. pressure, flow, or fill level). The processor unit CPU is connected with several memory units. A RAM memory serves as temporary working memory, a non-volatile EPROM memory or FLASH memory as memory for the control program to be executed in the processor unit CPU, and an EEPROM memory as memory for calibration and start parameter values, especially for the setup program of the processor unit CPU.

The control program defines the application-oriented functionality of the field device (measured value computation, envelope curve evaluation, linearization of the measured values, diagnostic tasks).

Further, the processor unit CPU is connected with a display/interaction unit D/I (e.g. LC-display with 3-5 push buttons).

For communication with the fieldbus segment SM1, the processor unit CPU is connected via a communication controller COM with a fieldbus interface FBI. A power supply unit PS delivers the necessary energy for individual electronic components of the field device F1. Power supply lines to the individual components are not drawn in order to avoid clutter.

Alternatively, power supply of the field device F1 occurs not over the fieldbus interface FBI, but instead via a separate voltage connection.

A UART interface of the processor unit CPU is connected with a service plug connection SE, which serves in the case of conventional field devices as a cable connection for a portable computer unit CU, for example a laptop. This interface with the field device is also often called the service interface S.

Via a computer unit CU, the field device F1 can for example, be serviced and configured over the service interface S.

On the basis of FIG. 3, production and use of an activation code AC are schematically represented.

At the field device manufacturer, in the manufacturing of a field device, an activation code AC is produced, from the serial number SN (e.g. FMU90-R22CA263AAla/84004D010E6) of the field device of concern and an activation option x (e.g. 0x00000010), with the help of a private key PrK (private key) of suitable length, for example 128 bit.

This encrypting with the help of a computer program (PC-Tool) is done in a safe area by the field device manufacturer. Only a very small group of people are allowed to know the private key PrK.

To activate the option X, for example a channel flow measurement with an ultrasonic, fill level, measuring device, the user acquires the appropriate activation code AC from the field device manufacturer.

This activation code AC is transferred by the user to a field device, for example the field device F1, with the help of a computer unit CU and an appropriate service program (operating tool), e.g. FieldCare.

In the field device F1, the activation code AC is decrypted with the help of a public key PuK stored in the field device F1.

The decrypted activation code AC now has at least two pieces of information, a serial number SN′ and an activation option x.

Then, the serial number SN′ obtained from the activation code AC is compared with the serial number SN stored in the field device F1.

If both serial numbers SN′ and SN agree, then the functionality that belongs to activation option x of the field device F1 is activated.

In this case, it is assured that the activation code is intended for that particular field device.

If the two serial numbers SN′ and SN do not agree, then the activation code AC is not intended for that particular field device and the operator is not entitled to use the functionality of the field device F1 corresponding to the option x.

Instead of the serial number SN, other device-specific information, which is stored in the field device, can be used for producing the activation code at the field device manufacturer.

The activation option x can also be a combination of different options.

The storage of the activation option x in the field device can be done in a removable memory.

The method according to the invention is very safe. A retrieval of the private key PrK is, with suitable length, impossible. Thus the activation code AC can only be successfully used with the field device that the manufacturer intended.

An unauthorized use of activation codes is thus ruled out.

Via a test tool TT, which the field device manufacturer puts at the user's disposal, the user, with the input of the acquired activation code AC, can display the relevant activation option and the matching serial number in cleartext.

The test tool can be, for example, a Java script application that runs on a PC of the user.

After the transfer and verification of the activation code AC as well as storage of the activation option x in the field device F1, a corresponding special functionality can be activated at a service tool attached to the field device F1.

The public key PuK and the employed method can be made known without hesitation. Frivolous users cannot obtain the private key PrK from this information, in order to generate activation codes for other field devices.

TABLE 1

| | |
|---|---|
| activation code | AC |
| activation option | x |
| amplifier | A |
| analog/digital converter | A/D |
| communication controller | COM |
| computer unit | CU |
| computer units | WS1, WS2 |
| data bus | D1 |
| display/interaction unit | D/I |
| EPROM memory | EPROM |
| field devices | F1, F2, F3, F4 |
| fieldbus | FB |
| fieldbus interface | FBI |
| fieldbus segment | SM1 |
| FLASH memory | FLASH |
| gateway | G1 |
| measuring transducer | MT |
| power supply unit | PS |
| private key | PrK |
| processor unit | CPU |
| public key | PuK |
| RAM memory | RAM |
| serial number | SN |
| service interface | S |
| UART interface | UART |

Translation of German words and/or symbols in the drawing

### FIG. 2:

### Change “MA” to --MT--;

change “V” to --A--;
change “A/B” to --D/I--;
change “FBS” to --FBI--;
change “NT” to --PS--; and
change “RE” to --CU--.

### FIG. 3:

### Change “Sicherer Bereich” to --Secure Area--;

change “Unsicherer Bereich” to --Insecure Area--;
change “Seriennummer” (all three occurrences) to --Serial Number--;
change “Fieldgeraet” to --Field Device--;
change “freigeschaltet” to --activated--;
change “Oeffentlicher Schluessel” (both occurrences) to --Public Key--;
change “Alphanummerische Zeichenkette” to --Alphanumeric Character String--;
change “FSC” to --AC--; and
change “Privater Schluessel” to --Private Key--.

1-5. (canceled)

6. A method for activating special functionalities in field devices used in automation technology, comprising the steps of:
transferring into a field device, encrypted with a private key, an activation code containing an activation option and field-device-specific information;
decrypting the activation code with a public key stored in the field device; comparing the field-device-specific information contained in the activation code with information stored in the field device; and
upon agreement of the field device specific information and the information stored in the field device, ascertaining the activation option contained in the activation code and activating its special functionality in the field device.

7. The method according to claim 6, wherein:
the field-device-specific information is the serial number of the field device.

8. The method according to claim 6, wherein:
the activation option is a combination of different options.

9. The method according to claim 6, further comprising the step of:
after transfer and verification of the activation code, as well as storage of the activation option in the field device, a corresponding special functionality is activated at a service tool attached to the field device.

10. The method according to claim 6, wherein:
the storage of the activation option in the field device takes place in a removable memory.
